(19) United States
(12) Patent Application Publication
(10) Pub. No.: US 2026/0354350 A1
(43) Pub. Date: Nov. 12, 2026

(54) ABSORBENT ARTICLE FOR PET, AND PACKAGE

(71) Applicant: Unicharm Corporation, Shikokuchuo-City, Ehime (JP)

(72) Inventors: Yumei TAKAHASHI, Kagawa (JP); Shinya KANEKO, Kagawa (JP)

(73) Assignee: Unicharm Corporation, Shikokuchuo-City, Ehime (JP)

(21) Appl. No.: 19/137,884

(22) PCT Filed: Nov. 29, 2024
(86) PCT No.: PCT/JP2024/042349

§ 371 Date: Jun. 11, 2025

(30) Foreign Application Priority Data
Dec. 8, 2023 (JP) 2023-207779

(51) Int. Cl. A01K 23/00

(52) U.S. Cl. CPC A01K 23/00

(57) ABSTRACT

An absorbent article for a pet according to one aspect includes a body portion having a longitudinal direction and a lateral direction, the body portion including a front surface sheet, a back surface sheet, and an absorber disposed, and the body portion including a first portion and a second portion, an engagement portion that is provided in the first portion of the body portion, a pair of leakage-preventing sheets capable of rising with respect to the front surface sheet along a pair of rising lines extending in the longitudinal direction, and a pair of outer elastic members provided outside the pair of rising lines in the lateral direction and expandable in the longitudinal direction. The body portion includes one or more inner elastic members provided inside the pair of rising lines in the lateral direction and imparting expandability to the body portion.

### TECHNICAL FIELD

The present disclosure relates to an absorbent article for a pet, and a package.

### BACKGROUND ART

Patent Literature 1 discloses an absorbent article for a pet worn by being wound around a body of a pet such as a dog or a cat. The absorbent article for a pet is suitably used for pets in which a urethral opening is positioned in front of a root of a hind foot, and includes a liquid-permeable surface layer, a liquid-impermeable back surface layer, an absorber disposed between the front surface layer and the back surface layer, and a pair of three-dimensional gather portions rising from the front surface layer. In such an absorbent article for a pet, the occurrence of urine leakage is suppressed by the pair of three-dimensional gather portions.

### CITATION LIST

### Patent Literature

Patent Literature 1: Japanese Unexamined Patent Publication No. 2012-205579

### SUMMARY OF INVENTION

### Technical Problem

In the absorbent article for a pet described above, a gap is generated between the absorbent article for a pet and a body of the pet due to changes in a body shape and posture of the pet, and urine leakage may occur.

Therefore, an object of the present disclosure is to provide an absorbent article for a pet capable of effectively suppressing urine leakage, and a package accommodating the absorbent article for a pet.

### Solution to Problem

In one aspect, there is provided an absorbent article for a pet worn by being wound around a body of a pet. The absorbent article for a pet includes a body portion having a horizontally long shape having a longitudinal direction and a lateral direction, the body portion including a front surface sheet disposed on a skin surface side, a back surface sheet disposed on a non-skin surface side, and an absorber disposed between the front surface sheet and the back surface sheet, and the body portion including a first portion disposed on one side in the longitudinal direction with respect to a center line of the body portion in the longitudinal direction, and a second portion disposed on the other side in the longitudinal direction with respect to the center line of the body portion in the longitudinal direction, an engagement portion that is provided in the first portion of the body portion and engages the first portion and the second portion, a pair of leakage-preventing sheets capable of rising with respect to the front surface sheet along a pair of rising lines extending in the longitudinal direction at positions apart from each other in the lateral direction, and a pair of outer elastic members provided outside the pair of rising lines in the lateral direction and expandable in the longitudinal direction. The body portion further includes one or more inner elastic members provided inside the pair of rising lines in the lateral direction and imparting expandability to the body portion.

### Advantageous Effects of Invention

According to various aspects of the present invention, urine leakage can be effectively suppressed.

### BRIEF DESCRIPTION OF DRAWINGS

FIG. 1 is a perspective view schematically illustrating an absorbent article for a pet according to one embodiment.

FIG. 2 is a plan view of the absorbent article for a pet as viewed from a skin surface side.

FIG. 3 is a sectional view of the absorbent article for a pet taken along line A-A in FIG. 1.

FIG. 4 is a sectional view of the absorbent article for a pet taken along line B-B in FIG. 1.

FIG. 5 is a sectional view of the absorbent article for a pet taken along line C-C in FIG. 1.

FIG. 6 is a plan view of an absorbent article for a pet according to another embodiment as viewed from a skin surface side.

FIG. 7 is a sectional view of the absorbent article for a pet illustrated in FIG. 6.

FIG. 8 is a plan view of an absorbent article for a pet according to still another embodiment as viewed from a skin surface side.

FIG. 9 is a plan view of an absorbent article for a pet according to still another embodiment as viewed from a skin surface side.

FIG. 10 is a sectional view illustrating a package according to one embodiment.

FIG. 11 is a diagram for explaining a procedure for folding the absorbent article for a pet.

FIG. 12 is a diagram illustrating a procedure subsequent to FIG. 11.

### DESCRIPTION OF EMBODIMENTS

### Overview of Embodiments of Present Disclosure

An overview of embodiments of the present disclosure will be described with reference to the following clauses. Note that, the present disclosure includes any combination of the following clauses.

### Clause 1

An absorbent article for a pet according to one aspect is worn by being wound around a body of the pet. The absorbent article for a pet includes a body portion having a horizontally long shape having a longitudinal direction and a lateral direction, the body portion including a front surface sheet disposed on a skin surface side, a back surface sheet disposed on a non-skin surface side, and an absorber disposed between the front surface sheet and the back surface sheet, and the body portion including a first portion disposed on one side in the longitudinal direction with respect to a center line of the body portion in the longitudinal direction, and a second portion disposed on the other side in the longitudinal direction with respect to the center line of the body portion in the longitudinal direction, an engagement portion that is provided in the first portion of the body portion and engages the first portion and the second portion, a pair of leakage-preventing sheets capable of rising with respect to the front surface sheet along a pair of rising lines extending in the longitudinal direction at positions apart from each other in the lateral direction, and a pair of outer elastic members provided outside the pair of rising lines in the lateral direction and expandable in the longitudinal direction. The body portion further includes one or more inner elastic members provided inside the pair of rising lines in the lateral direction and imparting expandability to the body portion.

In the above aspect, the pair of outer elastic members contract in the longitudinal direction, and thus, the pair of leakage-preventing sheets rises with respect to the front surface sheet and comes into close contact with the body of the pet. In addition, since the one or more inner elastic members provided inside the pair of rising lines in the lateral direction contract so as to follow changes in a body shape and posture of the pet, fitting of the absorbent article for a pet can be improved. As a result, generation of a gap between the absorbent article for a pet and the body of the pet is suppressed, and urine leakage can be effectively suppressed.

### Clause 2

In the absorbent article for a pet according to clause 1, the one or more inner elastic members may expand and contract in the longitudinal direction. In this case, since the one or more inner elastic members contract so as to follow the changes in the body shape and posture of the pet in the longitudinal direction, fitting of the absorbent article for a pet can be improved. As a result, urine leakage can be effectively suppressed.

### Clause 3

In the absorbent article for a pet according to clause 2, the one or more inner elastic members may extend over an entire region of the body portion in the longitudinal direction. In this case, since the body portion expands and contracts in the entire region in the longitudinal direction, the absorbent article for a pet can be fitted to the body of the pet over the entire region of the body of the pet when the absorbent article for a pet is worn. As a result, displacement of the absorbent article for a pet can be suppressed, and urine leakage can be more effectively suppressed.

### Clause 4

In the absorbent article for a pet according to any one of clauses 1 to 3, the engagement portion may be provided on a front surface of the front surface sheet and may be engageable with the back surface sheet. In this case, the absorbent article for a pet can be easily worn on the pet by using the engagement portion.

### Clause 5

In the absorbent article for a pet according to clause 4, the first portion may include an expandable region including the one or more inner elastic members, the second portion may include a non-expandable region not including the one or more inner elastic members, and a contraction rate of the first portion may be higher than a contraction rate of the second portion. In this case, the second portion having a relatively low contraction rate can be brought into contact with the body of the pet to align the absorbent article for a pet. In addition, when the second portion is engaged with the first portion, the first portion having a relatively high contraction rate contracts, and thus, loosening when the absorbent article for a pet is worn is reduced. Accordingly, fitting of the absorbent article for a pet can be improved.

### Clause 6

In the absorbent article for a pet according to any one of clauses 1 to 5, a center of the one or more inner elastic members in the longitudinal direction may be disposed on the one side in the longitudinal direction with respect to a center line of the absorber in the longitudinal direction. In this case, the region on one side of the body portion with respect to the center line of the absorber more easily expands and contracts than the region on the other side of the body portion. As a result, the region on the other side of the body portion is brought into contact with the body of the pet to easily align the absorbent article for a pet. In addition, when the first portion is engaged with the second portion, the region on one side of the body portion contracts, and thus, loosening when the absorbent article for a pet is worn is reduced.

### Clause 7

In the absorbent article for a pet according to any one of clauses 1 to 3, the engagement portion may be provided on an outer surface of the back surface sheet and may be engageable with the front surface sheet. In this case, the absorbent article for a pet can be easily worn on the pet by using the engagement portion.

### Clause 8

In the absorbent article for a pet according to clause 7, the first portion may include a non-expandable region not including the one or more inner elastic members, the second portion may include an expandable region including the one or more inner elastic members, and a contraction rate of the second portion may be higher than a contraction rate of the first portion. In this case, the first portion having a relatively low contraction rate can be brought into contact with the body of the pet to align the absorbent article for a pet. In addition, when the second portion is engaged with the first portion, the second portion having a relatively high contraction rate contracts, and thus, loosening when the absorbent article for a pet is worn can be reduced. Accordingly, fitting of the absorbent article for a pet can be improved.

### Clause 9

In the absorbent article for a pet according to clause 7 or 8, a center of the one or more inner elastic members in the longitudinal direction may be disposed on the other side in the longitudinal direction with respect to a center line of the absorber in the longitudinal direction. In this case, the region on the other side of the body portion with respect to the center line of the absorber has higher expandability than the region on one side of the body portion. As a result, the region on one side of the body portion is brought into contact with the body of the pet to easily align the absorbent article for a pet. In addition, when the first portion and the second portion are engaged with each other, since the region on the other side of the body portion contracts, loosening when the absorbent article for a pet is worn is reduced.

### Clause 10

In the absorbent article for a pet according to any one of clauses 1 to 9, the one or more inner elastic members may overlap the engagement portion as viewed from a thickness direction of the body portion. In this case, the first portion and the second portion are firmly engaged by the engagement portion being pulled by the contraction force of the inner elastic member. As a result, the absorbent article for a pet is prevented from unintentionally coming off.

### Clause 11

In the absorbent article for a pet according to any one of clauses 1 to 9, the one or more inner elastic members may not overlap the engagement portion as viewed from a thickness direction of the body portion. The one or more inner elastic members is disposed so as not to overlap the engagement portion, and thus, the engagement portion is prevented from being deformed in a wavy manner by the contraction force of the inner elastic member. Accordingly, the engagement between the first portion and the second portion is prevented from being unintentionally released.

### Clause 12

In the absorbent article for a pet according to any one of clauses 1 to 11, the one or more inner elastic members may not overlap the absorber as viewed from a thickness direction of the body portion. In this case, deformation of the absorber due to the expansion and contraction of the inner elastic member can be prevented.

### Clause 13

In the absorbent article for a pet according to any one of clauses 1 to 11, the one or more inner elastic members may overlap the absorber as viewed from a thickness direction of the body portion. In this case, even in a case where urine is absorbed by the absorber, the absorber is lifted up by the contraction force of the inner elastic member, and sagging of the absorber is suppressed. Thus, fitting of the absorbent article for a pet can be maintained.

### Clause 14

In the absorbent article for a pet according to any one of clauses 1 to 13, each of the pair of outer elastic members may continuously extend in the longitudinal direction. In this case, the absorbent article for a pet can be fitted to the body of the pet by the contraction force of the pair of outer elastic members.

### Clause 15

In the absorbent article for a pet according to any one of clauses 1 to 13, each of the pair of outer elastic members may be discontinuously formed. In this case, since the outer elastic member partially contracts in the longitudinal direction, it is possible to reduce the pressure on the body of the pet by the pair of outer elastic members.

### Clause 16

In the absorbent article for a pet according to any one of clauses 1 to 15, the pair of leakage-preventing sheets may include a front leakage-preventing sheet capable of rising along a first rising line of the pair of rising lines and a rear leakage-preventing sheet capable of rising along a second rising line of the pair of rising lines, and a maximum rising height of the front leakage-preventing sheet with the body portion as a reference may be higher than a maximum rising height of the rear leakage-preventing sheet with the body portion as the reference. In this case, when the absorbent article for a pet is worn such that the front leakage-preventing sheet is disposed on the head side of the pet, since the urine of the pet can be blocked by the front leakage-preventing sheet, urine leakage can be effectively suppressed.

### Clause 17

In the absorbent article for a pet according to any one of clauses 1 to 16, the body portion may include the plurality of inner elastic members, and the plurality of inner elastic members may be arrayed along the lateral direction. In this case, since each inner elastic member contracts so as to follow the changes in the body shape and posture of the pet, fitting of the absorbent article for a pet can be improved.

### Clause 18

An absorbent article for a pet according to another aspect is worn by being wound around the body of the pet. The absorbent article for a pet includes a body portion having a horizontally long shape having a longitudinal direction and a lateral direction, the body portion including a front surface sheet disposed on a skin surface side, a back surface sheet disposed on a non-skin surface side, and an absorber disposed between the front surface sheet and the back surface sheet, and the body portion including a first portion disposed on one side in the longitudinal direction with respect to a center line of the body portion in the longitudinal direction, and a second portion disposed on the other side in the longitudinal direction with respect to the center line of the body portion in the longitudinal direction, an engagement portion that is provided in the first portion of the body portion and engages the first portion and the second portion, and a pair of outer elastic members provided outside the absorber in the lateral direction and expandable in the longitudinal direction. The body portion further includes one or more inner elastic members disposed on the non-skin surface side with respect to the front surface sheet and imparting expandability to the body portion, and the one or more inner elastic members are provided inside the pair of outer elastic members in the lateral direction, and overlap the engagement portion as viewed from a thickness direction of the body portion.

In the absorbent article for a pet according to the above aspect, since the one or more inner elastic members contract so as to follow the changes in the body shape and posture of the pet, fitting of the absorbent article for a pet can be improved. As a result, generation of a gap between the absorbent article for a pet and the body of the pet is suppressed, and urine leakage can be effectively suppressed.

### Clause 19

In the absorbent article for a pet according to clause 18, when regions obtained by dividing the engagement portion into three equal regions in the lateral direction are defined as a front region, a central region, and a rear region in order from one side in the lateral direction, the one or more inner elastic members may overlap at least the central region as viewed from the thickness direction of the body portion. In this case, fitting of the absorbent article for a pet can be improved.

### Clause 20

The package according to one aspect accommodates the absorbent article for a pet according to any one of clauses 1 to 19. The body portion of the absorbent article for a pet includes a front flap portion and a rear flap portion disposed outside the absorber in the lateral direction, the pair of leakage-preventing sheets includes a front leakage-preventing sheet capable of rising along a first rising line of the pair of rising lines and a rear leakage-preventing sheet capable of rising along a second rising line of the pair of rising lines, and the absorbent article for a pet is accommodated in the package in a state where the body portion is folded in three or folded in four in the longitudinal direction after the front flap portion is folded inward along a folding line extending in the longitudinal direction so as to expose an inner edge of the front leakage-preventing sheet in the lateral direction.

In the above aspect, when the absorbent article for a pet folded in three or four is unfolded in the longitudinal direction, the inner edge in the lateral direction of the front leakage-preventing sheet is exposed. Accordingly, even in a case where the absorbent article for a pet is worn without spreading the front flap portion, the front leakage-preventing sheet comes into contact with the body of the pet. Thus, urine leakage can be suppressed by the front leakage-preventing sheet.

### Clause 21

In the package according to clause 20, the rear flap portion may not be folded inward in the lateral direction. Since the front flap portion is folded and the rear flap portion is not folded, the user can easily recognize a front-back orientation of the absorbent article for a pet when taking out the absorbent article for a pet from the package. As a result, it is easy to put the absorbent article for a pet on the pet in a correct orientation.

### Details of Embodiments of Present Disclosure

Hereinafter, embodiments of the present disclosure will be described in detail with reference to the drawings. In the description of the drawings, identical elements are denoted by identical reference signs, and redundant description will be omitted. The drawings may be partially simplified or exaggerated for ease of understanding, and dimensional ratios are not limited to those described in the drawings.

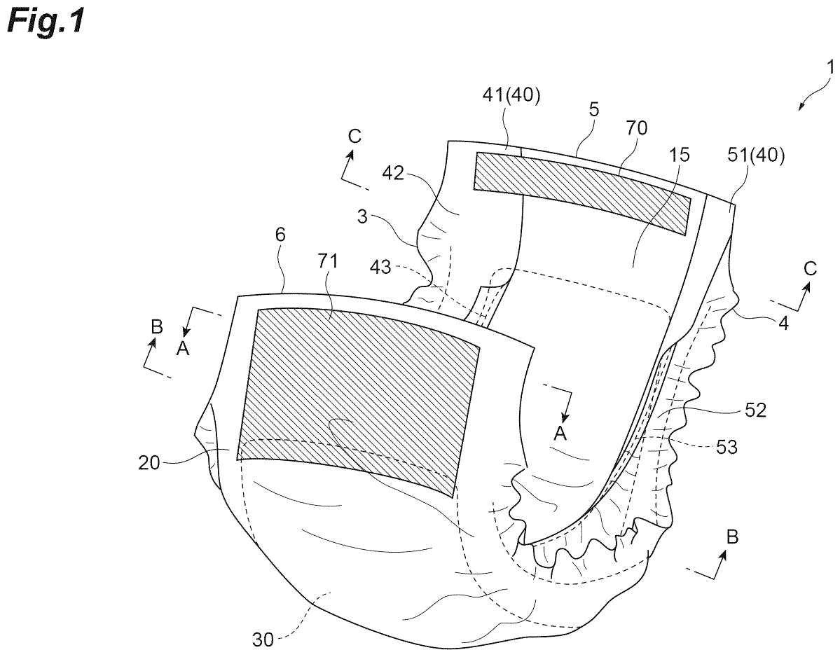

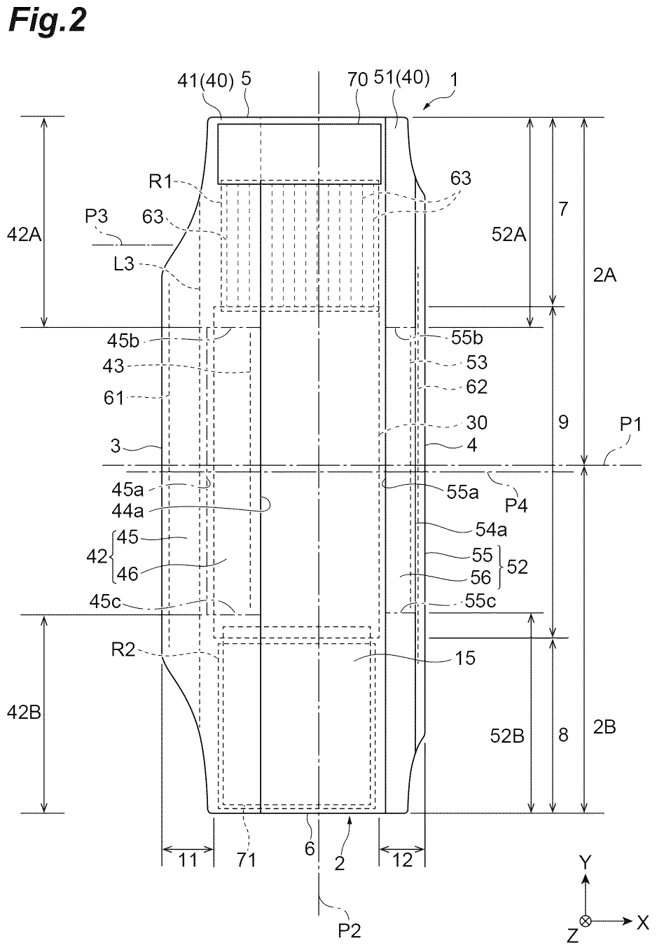

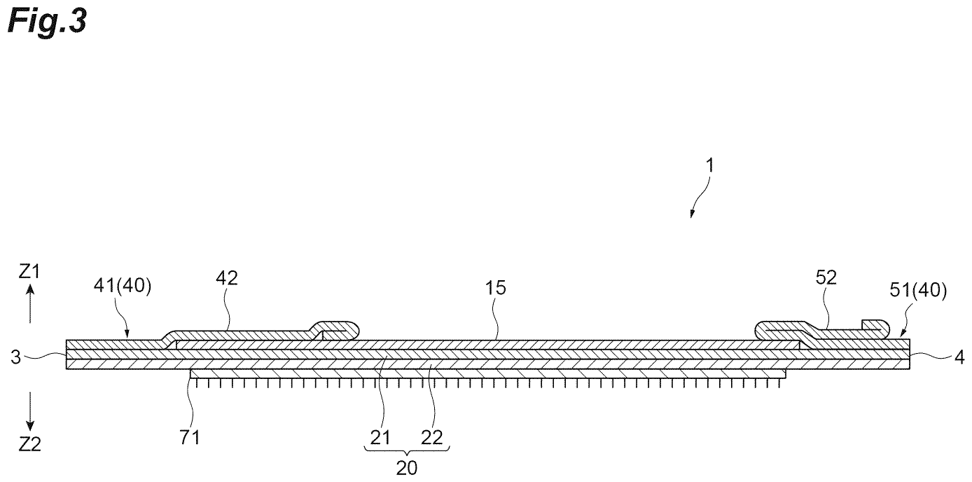

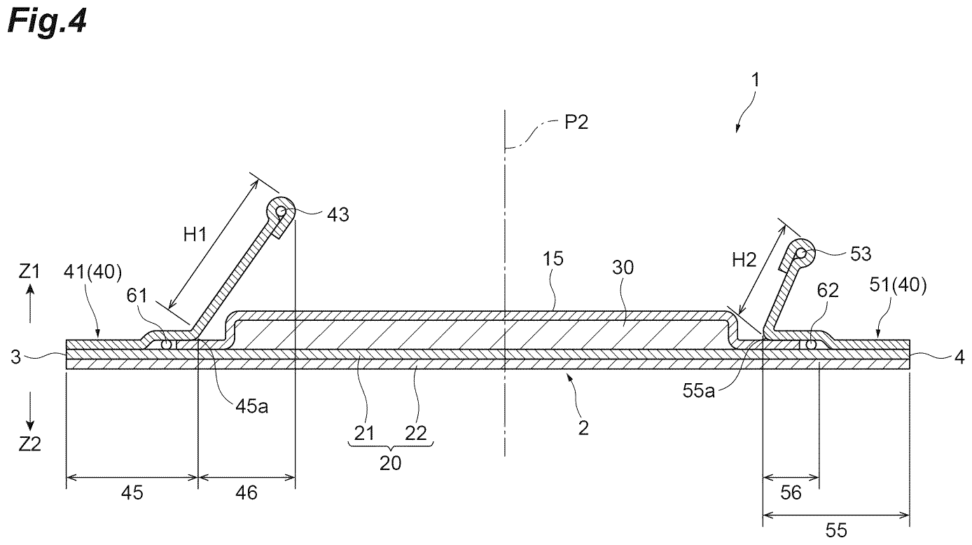

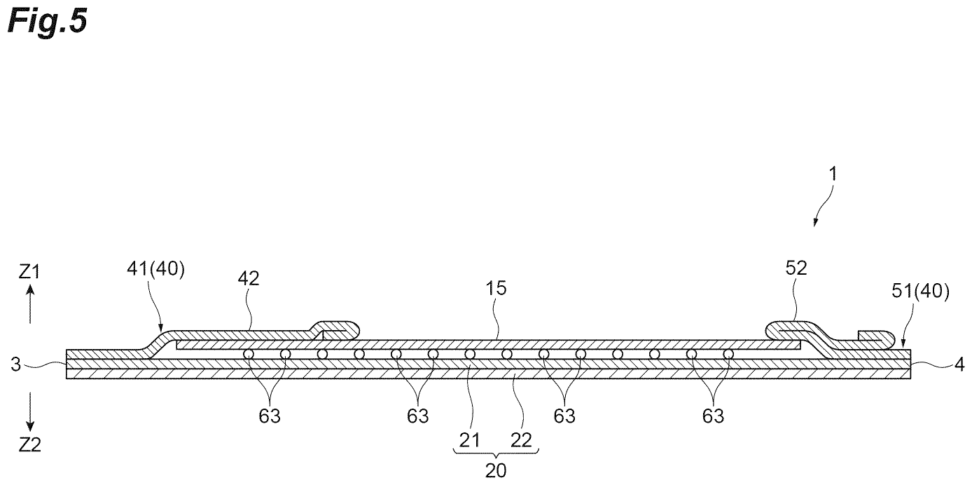

Hereinafter, an absorbent article for a pet according to one embodiment will be described. FIG. 1 is a perspective view schematically illustrating an absorbent article for a pet 1 according to one embodiment. FIG. 2 is a plan view of the absorbent article for a pet 1 as viewed from a skin surface side Z1. FIG. 3 is a sectional view of the absorbent article for a pet 1 taken along line A-A in FIG. 1. FIG. 4 is a sectional view of the absorbent article for a pet 1 taken along line B-B in FIG. 1. FIG. 5 is a sectional view of the absorbent article for a pet 1 taken along line C-C in FIG. 1. The absorbent article for a pet 1 illustrated in FIGS. 1 to 5 is a pet disposable diaper that absorbs urine of a pet.

FIG. 1 illustrates the absorbent article for a pet 1 in a natural state. The natural state means a state where an external force is not applied to the absorbent article for a pet 1. FIG. 2 illustrates the absorbent article for a pet 1 in an unfolded state. The unfolded state means a state where the absorbent article for a pet 1 is stretched to a state where wrinkles are not formed. The skin surface side Z1 is a side directed to a skin surface of the pet when the absorbent article for a pet 1 is in a putting state, and a non-skin surface side Z2 is a side directed to a side opposite to the skin surface of the pet when the absorbent article for a pet 1 is in the putting state. In the following description, a person who puts the absorbent article for a pet 1 is referred to as a “user”. Typically, the user is an owner of the pet. In the following description, a positional relationship in the unfolded state will be described unless otherwise specified.

In the present specification, pets broadly include vertebrates and invertebrates, and typically include pets such as dogs, cats, rabbits, and hamsters. The absorbent article for a pet 1 is particularly suitably used for male pets in which a urethral opening is positioned in front of a root of a hind leg. As illustrated in FIG. 2, the absorbent article for a pet 1 extends in a lateral direction X disposed along a front-back direction (direction connecting the head and the hips) of the pet and in a longitudinal direction Y disposed along a body direction of the pet. The lateral direction X and the longitudinal direction Y are directions perpendicular to each other. A thickness direction Z is a direction perpendicular to the lateral direction X and the longitudinal direction Y, and includes the skin surface side Z1 directed to the skin surface of the pet in the putting state and the non-skin surface side Z2 directed to the side opposite to the skin surface of the pet in the putting state. The absorbent article for a pet 1 is worn by being wound around the body of the pet.

The absorbent article for a pet 1 includes a body portion 2. The body portion 2 has a substantially rectangular (laterally long) planar shape having the lateral direction X and the longitudinal direction Y. Four corner portions of the body portion 2 are cut such that a width of the body portion 2 in the lateral direction X is narrowed. Note that, the four corner portions of the body portion 2 may not be cut. The body portion 2 has a front edge 3 disposed on one end side in the lateral direction X and a rear edge 4 disposed on the other end side in the lateral direction X. When the absorbent article for a pet 1 is worn on the pet, the front edge 3 is disposed on a front leg side of the pet, and the rear edge 4 is disposed on a hind leg side of the pet. In the following description, a direction from the rear edge 4 toward the front edge 3 may be referred to as a front side, and a direction from the front edge 3 toward the rear edge 4 may be referred to as a rear side. In addition, the body portion 2 has a first side edge 5 disposed on one end side in the longitudinal direction Y and a second side edge 6 disposed on the other end side in the longitudinal direction Y. In addition, the body portion 2 includes a first portion 2A disposed on one side in the longitudinal direction Y with respect to a center line P1 of the body portion 2 in the longitudinal direction Y, and a second portion 2B disposed on the other side in the longitudinal direction Y with respect to the center line P1 of the body portion 2 in the longitudinal direction Y.

As illustrated in FIGS. 1 to 5, the body portion 2 includes a front surface sheet 15, a back surface sheet 20, an absorber 30, and a pair of leakage-preventing sheets 40. The front surface sheet 15 constitutes a surface of the body portion 2 that is brought into contact with the pet, and is disposed on the skin surface side Z1. The front surface sheet 15 is liquid permeability that allows the urine of the pet to permeate to the absorber 30 side, for example. The front surface sheet 15 is positioned substantially at the center in the lateral direction X. Examples of a nonwoven fabric constituting the front surface sheet 15 include an air-through nonwoven fabric, a spunbonded nonwoven fabric, a point bonded nonwoven fabric, and the like. The front surface sheet 15 is joined to the back surface sheet 20 and the absorber 30 with, for example, a hot melt adhesive.

The back surface sheet 20 constitutes a surface of the body portion 2 positioned on an outer side when the pet wears the absorbent article for a pet, and is disposed on the non-skin surface side Z2. The back surface sheet 20 includes a liquid-impermeable back surface film 21 and a back surface nonwoven fabric 22 disposed on the non-skin surface side Z2 with respect to the back surface film 21. In the lateral direction X, the back surface film 21 has a width substantially equal to a width of the back surface nonwoven fabric 22. Note that, in the lateral direction X, the width of the back surface film 21 may be narrower than the width of the back surface nonwoven fabric 22, and the back surface nonwoven fabric 22 may extend to both sides in the lateral direction X with respect to the back surface film 21. The back surface nonwoven fabric 22 constitutes an outermost layer of the absorbent article for a pet 1. The back surface film 21 is joined to the back surface nonwoven fabric 22 and the absorber 30 with, for example, a hot melt adhesive.

The absorber 30 is disposed between the front surface sheet 15 and the back surface sheet 20. The absorber 30 is positioned substantially at the center of the body portion 2 and absorbs the urine of the pet. The absorber 30 has a substantially rectangular shape extending in the longitudinal direction Y.

The body portion 2 includes a first end portion 7 disposed on one side in the longitudinal direction Y, a second end portion 8 disposed on the other end side in the longitudinal direction Y, and a central portion 9 disposed between the first end portion 7 and the second end portion 8. In one embodiment, the first end portion 7 is a region positioned between the absorber 30 and the first side edge 5 in the longitudinal direction Y. The second end portion 8 is a region positioned between the absorber 30 and the second side edge 6 in the longitudinal direction Y. The central portion 9 is a region disposed between the first end portion 7 and the second end portion 8 in the longitudinal direction Y. In one embodiment, a width of the first end portion 7 in the lateral direction X is narrowed toward the first side edge 5, and a width of the second end portion 8 in the lateral direction X is narrowed toward the second side edge 6. The widths of the first end portion 7 and the second end portion 8 are narrowed, and thus, the user can easily grip the first end portion 7 and the second end portion 8. The first end portion 7 is a part of the first portion 2A, and the second end portion 8 is a part of the second portion 2B.

The body portion 2 includes a front flap portion 11 and a rear flap portion 12 disposed outside the absorber 30 in the lateral direction X. The front flap portion 11 is disposed along the front edge 3, and the rear flap portion 12 is disposed along the rear edge 4.

In one embodiment, the absorber 30 includes an absorbent core including pulp having water absorbency and a super-absorbent polymer (SAP), and a core wrap covering a front surface of the absorbent core. For example, chemical pulp, cellulose fiber, and cellulose fiber such as rayon and acetate are used as the pulp of the absorbent core. For example, starch-based, acrylic acid-based, and amino acid-based particulate or fibrous polymers are used as the super-absorbent polymer. Note that, the absorber 30 may be an SAP sheet that does not contain pulp and mainly contains SAP.

The pair of leakage-preventing sheets 40 is provided on the front surface sheet 15 and is disposed apart from each other in the lateral direction X. The pair of leakage-preventing sheets 40 is disposed so as to cover both side portions of the front surface sheet 15 in the lateral direction X from the skin surface side Z1, and extends in the longitudinal direction Y over an entire length of the body portion 2 in the longitudinal direction Y. The pair of leakage-preventing sheets 40 is partially joined to the front surface sheet 15 or the back surface sheet 20 outside the absorber 30 in the lateral direction X. The pair of leakage-preventing sheets 40 stands rising with respect to the front surface sheet 15 to suppress leakage of urine of a pet excreted in the absorber 30 in the lateral direction X. The pair of leakage-preventing sheets 40 includes a front leakage-preventing sheet 41 provided along the front edge 3 and a rear leakage-preventing sheet 51 provided along the rear edge 4. The pair of leakage-preventing sheets 40 may be formed by winding back the back surface nonwoven fabric 22 toward the front surface sheet 15 on the outer side of the body portion 2 in the lateral direction X. In this case, a part of the back surface nonwoven fabric 22 wound back to the front surface sheet 15 side constitutes the pair of leakage-preventing sheets 40, and the other part of the back surface nonwoven fabric 22 constitutes the back surface sheet 20 of the body portion 2.

In one embodiment, the front leakage-preventing sheet 41 includes a side sheet 42 partially fixed to the front surface sheet 15 or the back surface sheet 20, and a first elastic member 43 joined to the side sheet 42. The rear leakage-preventing sheet 51 includes a side sheet 52 partially fixed to the front surface sheet 15 or the back surface sheet 20, and a first elastic member 53 joined to the side sheet 52. Each of the pair of side sheets 42 and 52 is made of a nonwoven fabric having water repellency or hydrophobicity. For example, the side sheets 42 and 52 are made of a spunlace nonwoven fabric, a spunbond nonwoven fabric, a thermal bond nonwoven fabric, a melt-blown nonwoven fabric, an SMS nonwoven fabric, a needle punch nonwoven fabric, an air-through nonwoven fabric, or the like.

Each of the pair of side sheets 42 and 52 has a vertically long shape that is long in the longitudinal direction Y, and extends in the longitudinal direction Y over the entire length of the body portion 2 in the longitudinal direction Y. As illustrated in FIGS. 3 to 5, an outer edge of the front leakage-preventing sheet 41 in the lateral direction X coincides with outer edges of the back surface film 21 and the back surface nonwoven fabric 22 in the lateral direction X, and constitutes the front edge 3 together with the outer edges of the back surface film 21 and the back surface nonwoven fabric 22. An outer edge of the rear leakage-preventing sheet 51 in the lateral direction X coincides with outer edges of the back surface film 21 and the back surface nonwoven fabric 22 in the lateral direction, and constitutes the rear edge 4 together with the outer edges of the back surface film 21 and the back surface nonwoven fabric 22.

As illustrated in FIGS. 2 and 5, the side sheet 42 includes a fixed portion 45 joined to the front surface sheet 15 or the back surface sheet 20, and a rising portion 46 not joined to the front surface sheet 15. A first rising line 45a, a second rising line 45b, and a third rising line 45c are formed at a boundary between the fixed portion 45 and the rising portion 46.

The first rising line 45a is disposed between a center line P2 of the body portion 2 in the lateral direction X and the front edge 3, and extends in the longitudinal direction Y. For example, the first rising line 45a is disposed between an edge of the absorber 30 on a front side and the front edge 3. The first rising line 45a is a boundary line between the fixed portion 45 and the rising portion 46 in the lateral direction X, and serves as a rising fulcrum with respect to the rising portion 46 in the lateral direction X. Note that, the first rising line 45a may partially overlap the absorber 30 as viewed from the thickness direction Z.

The second rising line 45b is disposed between the center line P1 of the body portion 2 in the longitudinal direction Y and the first side edge 5, and extends in the lateral direction X. For example, the second rising line 45b is disposed closer to the center line P1 than the edge of the absorber 30 on the first side edge 5 side in the longitudinal direction Y. The second rising line 45b is a boundary line between the fixed portion 45 and the rising portion 46 in the longitudinal direction Y, and serves as a rising fulcrum with respect to the rising portion 46 in the longitudinal direction Y. Note that, the second rising line 45b may be disposed closer to the first side edge 5 than the edge of the absorber 30 on the first side edge 5 side in the longitudinal direction Y.

The third rising line 45c is disposed between the center line P1 of the body portion 2 in the longitudinal direction Y and the second side edge 6, and extends in the lateral direction X. For example, the third rising line 45c is disposed closer to the center line P1 than the edge of the absorber 30 on the second side edge 6 side in the longitudinal direction Y. The third rising line 45c is a boundary line between the fixed portion 45 and the rising portion 46 in the longitudinal direction Y, and serves as a rising fulcrum with respect to the rising portion 46 in the longitudinal direction Y. Note that, the third rising line 45c may be disposed closer to the second side edge 6 side than the edge of the absorber 30 on the second side edge 6 side in the longitudinal direction Y.

As described above, a first region 42A of the side sheet 42 closer to the first side edge 5 than the second rising line 45b is a part of the fixed portion 45, and is joined to the body portion 2 with a hot melt adhesive in a state of falling inward in the lateral direction X. Similarly, a second region 42B of the side sheet 42 closer to the second side edge 6 than the third rising line 45c is a part of the fixed portion 45, and is joined to the body portion 2 with a hot melt adhesive in a state of falling inward in the lateral direction X. Accordingly, as illustrated in FIGS. 3 and 5, the first region 42A and the second region 42B of the side sheet 42 are non-rising regions that are fixed to the body portion 2 and do not rise.

In contrast, the rising portion 46 is a rising region that is disposed between the first region 42A and the second region 42B and is not connected to the body portion 2. The rising portion 46 is disposed inside the first rising line 45a in the lateral direction X, and can rise along the first rising line 45a between the first region 42A and the second region 42B. Note that, since the first region 42A and the second region 42B of the side sheet 42 are joined to the body portion 2, the rising portion 46 falls inward in the lateral direction X in the unfolded state.

An inner portion of the rising portion 46 in the lateral direction X is folded back, and the first elastic member 43 is disposed between the folded rising portions 46. Accordingly, as illustrated in FIG. 2, the first elastic member 43 of the front leakage-preventing sheet 41 is disposed along an inner edge 44a of the rising portion 46. The first elastic member 43 is joined to the side sheet 42 in a state of being stretched in the longitudinal direction Y. The first elastic member 43 is made of, for example, an expandable material such as rubber or spandex that can contract in a length direction.

As illustrated in FIG. 4, the first elastic member 43 contracts in the longitudinal direction Y in the natural state, and thus, the rising portion 46 of the side sheet 42 rises along the first rising line 45a on the outer side of the absorber 30 in the lateral direction X. The rising portion 46 of the front leakage-preventing sheet 41 rises, and thus, the urine of the pet is prevented from leaking to the front side along the front surface of the front surface sheet 15.

The side sheet 52 includes a fixed portion 55 joined to the front surface sheet 15 or the back surface sheet 20, and a rising portion 56 not joined to the front surface sheet 15. A fourth rising line 55a, a fifth rising line 55b, and a sixth rising line 55c are formed at a boundary between the fixed portion 55 and the rising portion 56.

The fourth rising line 55a is disposed between the center line P2 of the body portion 2 in the lateral direction X and the rear edge 4, and extends in the longitudinal direction Y. For example, the fourth rising line 55a is disposed between the edge of the absorber 30 on a rear side and the rear edge 4. The fourth rising line 55a is a boundary line between the fixed portion 55 and the rising portion 56 in the lateral direction X, and serves as a rising fulcrum with respect to the rising portion 56 in the lateral direction X. Note that, the fourth rising line 55a may partially overlap the absorber 30 as viewed from the thickness direction Z.

The fifth rising line 55b is disposed between the center line P1 of the body portion 2 in the longitudinal direction Y and the first side edge 5, and extends in the lateral direction X. For example, the fifth rising line 55b is disposed closer to the center line P1 than the edge of the absorber 30 on the first side edge 5 side in the longitudinal direction Y. The fifth rising line 55b is a boundary line between the fixed portion 55 and the rising portion 56 in the longitudinal direction Y, and serves as a rising fulcrum with respect to the rising portion 56 in the longitudinal direction Y. Note that, the fifth rising line 55b may be disposed closer to the first side edge 5 side than the edge of the absorber 30 on the first side edge 5 side in the longitudinal direction Y.

The sixth rising line 55c is disposed between the center line P1 of the body portion 2 in the longitudinal direction Y and the second side edge 6, and extends in the lateral direction X. For example, the sixth rising line 55c is disposed closer to the center line P1 than the edge of the absorber 30 on the second side edge 6 side in the longitudinal direction Y. The sixth rising line 55c is a boundary line between the fixed portion 55 and the rising portion 56 in the longitudinal direction Y, and serves as a rising fulcrum with respect to the rising portion 56 in the longitudinal direction Y. Note that, the sixth rising line 55c may be disposed closer to the second side edge 6 side than the edge of the absorber 30 on the second side edge 6 side in the longitudinal direction Y.

As described above, a first region 52A of the side sheet 52 closer to the first side edge 5 than the fifth rising line 55b is a part of the fixed portion 55, and is joined to the body portion 2 with a hot melt adhesive in a state of being folded back to the outside in the lateral direction X. More specifically, the first region 52A is folded back to the outside in the lateral direction X along an extension line of the fourth rising line 55a, a lower layer of the folded first region 52A is joined to the front surface sheet 15 or the back surface sheet 20, and an upper layer of the folded first region 52A is joined to the lower layer. Similarly, the second region 52B of the side sheet 52 closer to the second side edge 6 than the sixth rising line 55c is a part of the fixed portion 55, and is joined to the body portion 2 with a hot melt adhesive in a state of being folded back to the outside in the lateral direction X. More specifically, the second region 52B is folded back to the outside in the lateral direction X along the extension line of the fourth rising line 55a, a lower layer of the folded second region 52B is joined to the front surface sheet 15 or the back surface sheet 20, and an upper layer of the folded second region 52B is joined to the lower layer. Accordingly, as illustrated in FIGS. 3 and 5, the first region 52A and the second region 52B of the side sheet 52 are non-rising regions that are fixed to the body portion 2 and do not rise.

In contrast, the rising portion 56 is a rising region that is disposed between the first region 52A and the second region 52B and is not connected to the body portion 2. The rising portion 56 is disposed inside the fourth rising line 55a in the lateral direction X, and can rise along the fourth rising line 55a between the first region 52A and the second region 52B. Note that, since the first region 52A and the second region 52B of the side sheet 52 are joined to the body portion 2 in a state of being folded back to the outside in the lateral direction X, the rising portion 56 falls outward in the lateral direction X in the unfolded state. The rising portion 56 falls outward in the lateral direction X in the unfolded state, the first elastic member 53 of the rear leakage-preventing sheet 51 is prevented from rubbing against a genital organ of the pet when the absorbent article for a pet 1 is worn. Note that, each of the first region 52A and the second region 52B may be joined to the body portion 2 without being folded back to the outside in the lateral direction X. In this case, the rising portion 56 falls inward in the lateral direction X in the unfolded state.

An inner portion of the rising portion 56 in the lateral direction X is folded back, and the first elastic member 53 is disposed between the folded rising portions 56. Accordingly, as illustrated in FIG. 2, the first elastic member 53 of the rear leakage-preventing sheet 51 is disposed along an inner edge 54a of the rising portion 56. The first elastic member 53 is joined to the side sheet 52 in a state of being stretched in the longitudinal direction Y. The first elastic member 53 is made of, for example, an expandable material such as rubber or spandex that can contract in a length direction.

As illustrated in FIG. 4, the first elastic member 53 contracts in the longitudinal direction Y in the natural state, and thus, the rising portion 56 of the side sheet 52 rises along the fourth rising line 55a on the outer side of the absorber 30 in the lateral direction X. The rising portion 56 of the rear leakage-preventing sheet 51 rises, and thus, the urine of the pet is prevented from leaking along the front surface of the front surface sheet 15.

As illustrated in FIG. 4, a maximum rising height H1 of the front leakage-preventing sheet 41 with the body portion 2 as a reference may be higher than a maximum rising height H2 of the rear leakage-preventing sheet 51 with the body portion 2 as a reference. The maximum rising height H1 corresponds to a height of a top portion of the front leakage-preventing sheet 41 with the body portion 2 as the reference when the front leakage-preventing sheet 41 rises perpendicularly to the body portion 2. In other words, the maximum rising height H1 can also be said to be a length along a front surface of the front leakage-preventing sheet 41 from the first rising line 45a to a top portion of the rising portion 46 in a section along the lateral direction X. Similarly, the maximum rising height H2 corresponds to a height of a top portion of the rear leakage-preventing sheet 51 with the body portion 2 as a reference when the rear leakage-preventing sheet 51 rises perpendicularly to the body portion 2. In other words, the maximum rising height H2 can also be said to be a length along a front surface of the rear leakage-preventing sheet 51 from the fourth rising line 55a to a top portion of the rising portion 56 in a section along the lateral direction X. The maximum rising height H1 is set to be higher than the maximum rising height H2. Thus, when the absorbent article for a pet 1 is worn such that the front leakage-preventing sheet 41 is disposed on the head side of the pet, since the urine vigorously discharged from the pet can be blocked by the front leakage-preventing sheet 41, urine leakage can be effectively suppressed. Note that, the maximum rising height H2 of the rear leakage-preventing sheet 51 may be higher than the maximum rising height H1 of the front leakage-preventing sheet 41. In this case, since the urine flowing to the rear side can be blocked by the rear leakage-preventing sheet 51, urine leakage can be effectively suppressed.

The body portion 2 further includes a pair of outer elastic members 61 and 62 expandable in the longitudinal direction Y and a plurality of inner elastic members 63 expandable in the longitudinal direction Y. The outer elastic members 61 and 62 and the inner elastic members 63 are disposed between the front surface sheet 15 and the back surface sheet 20. The outer elastic members 61 and 62 and the inner elastic members 63 expand and contract so as to follow changes in a body shape and posture of the pet in the longitudinal direction Y (for example, a motion in which the pet twists the body, and the like). Each of the outer elastic members 61 and 62 and the inner elastic members 63 is made of an expandable material such as rubber, an expandable nonwoven fabric, an expandable film, or spandex.

The outer elastic member 61 is provided outside the first rising line 45a in the lateral direction X and extends along the front edge 3. The outer elastic member 62 is provided outside the fourth rising line 55a in the lateral direction X and extends along the rear edge 4. Each of the outer elastic members 61 and 62 extends continuously in the longitudinal direction Y between the first end portion 7 and the second end portion 8. Note that, the body portion 2 may include a plurality of outer elastic members 61 and a plurality of outer elastic members 62. In addition, the numbers of outer elastic members 61 and 62 may be different from each other.

The outer elastic members 61 and 62 are disposed, for example, between the pair of leakage-preventing sheets 40 and the back surface sheet 20. The outer elastic members 61 and 62 are joined to the leakage-preventing sheet 40 and the back surface sheet 20 by a hot melt adhesive in a state of being stretched in the longitudinal direction Y. That is, the outer elastic members 61 and 62 are disposed on the non-skin surface side Z2 with respect to the pair of leakage-preventing sheets 40. Each of the outer elastic members 61 and 62 may overlap at least one of the first end portion 7 and the second end portion 8 as viewed from the thickness direction Z, or may not overlap both the first end portion 7 and the second end portion 8 as viewed from the thickness direction Z.

The plurality of inner elastic members 63 are provided inside the first rising line 45a and the fourth rising line 55a in the lateral direction X to impart expandability to the body portion 2. In one embodiment, the plurality of inner elastic members 63 are provided at the first end portion 7 of the body portion 2 to impart expandability to the first end portion 7. More specifically, the plurality of inner elastic members 63 extend between the absorber 30 and an engagement portion 70 to be described later. Accordingly, a center P3 of the inner elastic member 63 in the longitudinal direction Y is disposed on the first side edge 5 side with respect to a center line P4 of the absorber 30 in the longitudinal direction Y. As described above, since the inner elastic member 63 does not overlap the absorber 30 as viewed from the thickness direction Z, it is possible to prevent deformation of the absorber 30 due to a contraction force of the inner elastic member 63.

The plurality of inner elastic members 63 may be arrayed at equal intervals along the lateral direction X between the first rising line 45a and the fourth rising line 55a. The number of inner elastic members 63 is any number of 1 or more. The inner elastic member 63 is disposed on the non-skin surface side Z2 with respect to the front surface sheet 15. For example, the inner elastic member 63 is disposed between the front surface sheet 15 and the back surface film 21, and is joined to the front surface sheet 15 and the back surface film 21 with a hot melt adhesive in a state of being stretched in the longitudinal direction Y. The inner elastic member 63 is disposed on the non-skin surface side Z2 with respect to the front surface sheet 15. Thus, since it is possible to prevent the inner elastic member 63 from directly coming into contact with the body of the pet when the absorbent article for a pet 1 is worn, a wearing feeling of the absorbent article for a pet 1 can be improved.

Note that, the plurality of inner elastic members 63 may extend in the lateral direction X between the first rising line 45a and the fourth rising line 55a, and may be expandable in the lateral direction X. In this case, since the body portion 2 can be expanded and contracted so as to follow the changes in the body shape and posture of the pet in the lateral direction X (for example, a motion in which the pet stretches the body, and the like), the fitting of the absorbent article for a pet 1 can be improved.

Note that, the outer elastic members 61 and 62 and the inner elastic members 63 may be joined to the front surface sheet 15 or the back surface sheet 20 without using a hot melt adhesive. For example, the outer elastic members 61 and 62 and the inner elastic members 63 may be joined to the front surface sheet 15 or the back surface sheet 20 by sonic processing.

The first portion 2A of the body portion 2 includes an expandable region R1 including the inner elastic member 63, and the second portion 2B of the body portion 2 includes a non-expandable region R2 not including the inner elastic member 63. In the embodiment illustrated in FIG. 2, the first end portion 7 includes the expandable region R1, and the second end portion 8 includes the non-expandable region R2. Accordingly, a contraction rate of the first portion 2A is higher than a contraction rate of the second portion 2B. That is, a contraction rate of the first end portion 7 is higher than a contraction rate of the second end portion 8. In a case where a length of the first portion 2A or the second portion 2B in the natural state in the longitudinal direction Y is L1 and a length of the first portion 2A or the second portion 2B in the unfolded state in the longitudinal direction Y is L2, a contraction rate [%] is represented by (L2−L 1/L2×100. Note that, a part of the plurality of inner elastic members 63 may extend to the middle of the second portion 2B, and only a part of the second portion 2B may constitute the non-expandable region R2. Note that, in one embodiment, the inner elastic member 63 may be provided on both the first end portion 7 and the second end portion 8. In this case, the first portion 2A and the second portion 2B may have the same contraction rate.

The absorbent article for a pet 1 further includes the engagement portion 70. The engagement portion 70 is a member that engages the first portion 2A and the second portion 2B. As illustrated in FIGS. 1 and 2, the engagement portion 70 has a rectangular shape long in the lateral direction X, and is provided at the first end portion 7 of the first portion 2A. The engagement portion 70 is provided on the front surface of the front surface sheet 15. The engagement portion 70 is, for example, a mechanical fastener having a large number of hooks, and can be engaged with the back surface sheet 20 from the non-skin surface side Z2.

In one embodiment, a target portion 71 is provided on an outer surface of the back surface sheet 20 of the second portion 2B. The target portion 71 may overlap the absorber 30 and the second end portion 8 as viewed from the thickness direction Z. When the absorbent article for a pet 1 is worn, the engagement portion 70 is engaged with the back surface sheet 20 via the target portion 71 provided on the back surface sheet 20. Note that, the engagement portion 70 may be directly engageable with the back surface sheet 20.

Note that, as viewed from the thickness direction Z, the plurality of inner elastic members 63 may be disposed so as not to overlap the engagement portion 70 and the target portion 71. As a result, the engagement portion 70 and the target portion 71 are prevented from being deformed in a wavy manner by the contraction force of the plurality of inner elastic members 63.

The absorbent article for a pet 1 having the above configuration can be worn on the pet as follows. First, the user presses the second end portion 8 of the absorbent article for a pet 1 against the back of the pet, and presses the vicinity of the second end portion 8 with one hand. Next, the user holds the first end portion 7 of the absorbent article for a pet 1 with the other hand, and winds the absorbent article for a pet 1 so as to cover the belly of the pet. At this time, the absorbent article for a pet 1 is worn such that the front leakage-preventing sheet 41 is disposed in front of the pet with respect to the urethral opening and the rear leakage-preventing sheet 51 is disposed behind the pet with respect to the urethral opening. Next, the user pulls up the first end portion 7 such that the absorbent article for a pet 1 comes into close contact with the body of the pet, and then engages the engagement portion 70 of the second end portion 8 with the target portion 71. The engagement portion 70 is engaged with the target portion 71 in this manner, and thus, the absorbent article for a pet 1 can be worn on the pet at an appropriate position.

Since the contraction rate of the first portion 2A is higher than the contraction rate of the second portion 2B, the second portion 2B is brought into contact with the body of the pet to easily align the absorbent article for a pet 1. In addition, since the first portion 2A contracts and the absorbent article for a pet 1 comes into close contact with the body of the pet, the fitting of the absorbent article for a pet 1 is improved.

As described above, in the absorbent article for a pet 1, the pair of outer elastic members 61 and 62 contracts in the longitudinal direction Y, and thus, the pair of leakage-preventing sheets 40 rises with respect to the body portion 2 and comes into close contact with the body of the pet. In addition, since the plurality of inner elastic members 63 provided between the first rising line 45a and the fourth rising line 55a contract so as to follow the changes in the body shape and posture of the pet, the fitting of the absorbent article for a pet 1 can be improved. As a result, generation of a gap between the absorbent article for a pet 1 and the body of the pet is suppressed, and urine leakage can be effectively suppressed.

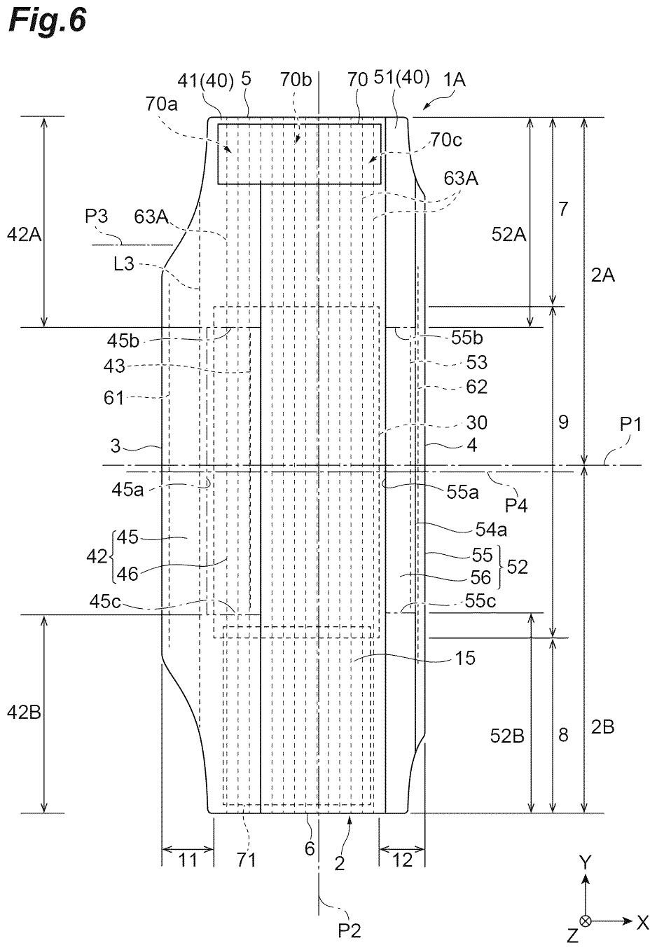

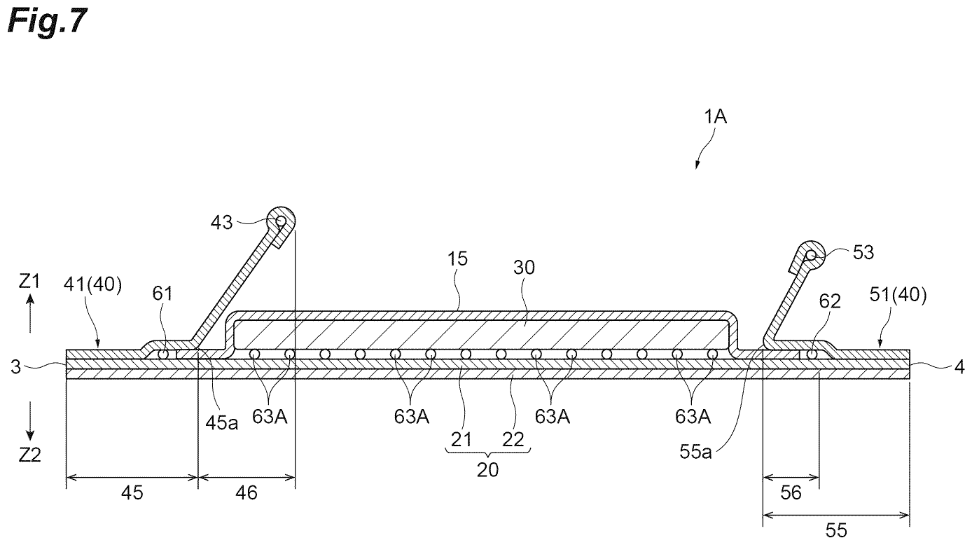

Next, an absorbent article for a pet according to another embodiment will be described. FIG. 6 is a plan view of an absorbent article for a pet 1A according to another embodiment as viewed from the skin surface side Z1. FIG. 7 is a sectional view schematically illustrating the absorbent article for a pet 1A. The absorbent article for a pet 1A is different from the absorbent article for a pet 1 illustrated in FIG. 1 in that the body portion 2 includes a plurality of inner elastic members 63A instead of the plurality of inner elastic members 63. In the following description, differences from the absorbent article for a pet 1 will be mainly described, and redundant description will be omitted.

The body portion 2 of the absorbent article for a pet 1A includes the plurality of inner elastic members 63A expandable in the longitudinal direction Y. The plurality of inner elastic members 63A are provided inside the pair of outer elastic members 61 and 62 in the lateral direction X, and extend over the entire region of the body portion 2 in the longitudinal direction Y. As a result, since the body portion 2 expands and contracts over the entire region in the longitudinal direction Y so as to follow the changes in the body shape and posture of the pet, the fitting of the absorbent article for a pet 1A is effectively improved.

The plurality of inner elastic members 63A overlap the entire region of the absorber 30 in the longitudinal direction Y as viewed from the thickness direction Z. As a result, even in a case where the urine is absorbed in the absorber 30, the absorber 30 is lifted up by a contraction force of the inner elastic member 63A, and sagging of the absorber 30 is suppressed. Accordingly, the fitting of the absorbent article for a pet 1A can be maintained.

The plurality of inner elastic members 63A are disposed on the non-skin surface side Z2 with respect to the front surface sheet 15. In particular, as illustrated in FIG. 7, a part of the plurality of inner elastic members 63A is disposed between the absorber 30 and the back surface sheet 20. Note that, an intermediate sheet made of a nonwoven fabric may be disposed between a part of the plurality of inner elastic members 63A and the absorber 30.

The inner elastic member 63A may overlap the engagement portion 70 as viewed from the thickness direction Z. For example, when regions obtained by dividing the engagement portion 70 into three equal regions in the lateral direction X are defined as a front region 70a, a central region 70b, and a rear region 70c in order from the front side, the plurality of inner elastic members 63A overlap at least the central region 70b as viewed from the thickness direction Z. As illustrated in FIG. 6, the plurality of inner elastic members 63A may overlap all of the front region 70a, the central region 70b, and the rear region 70c as viewed from the thickness direction Z. In a case where the target portion 71 is provided as in the present embodiment, the inner elastic member 63A may overlap the target portion 71 as viewed from the thickness direction Z. Note that, the outer elastic members 61 and 62 are positioned outside the engagement portion 70 in the lateral direction X.

As described above, in the absorbent article for a pet 1A, since the body portion 2 expands and contracts over the entire region in the longitudinal direction Y so as to follow the changes in the body shape and posture of the pet, the fitting property of the absorbent article for a pet 1A can be improved. As a result, generation of a gap between the absorbent article for a pet 1A and the body of the pet is suppressed, and urine leakage can be effectively suppressed.

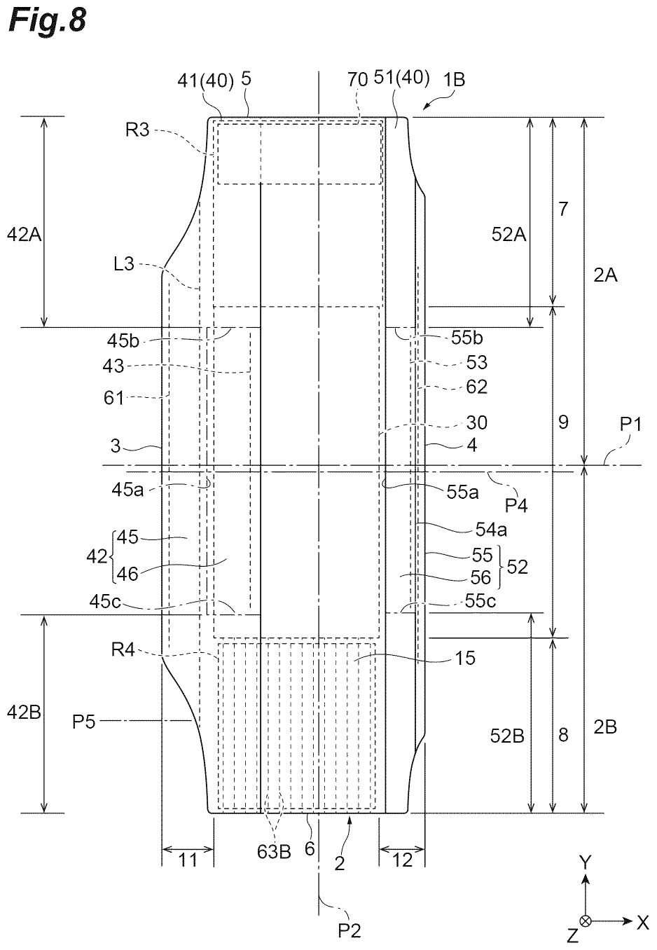

Next, an absorbent article for a pet according to still another embodiment will be described. FIG. 8 is a plan view of an absorbent article for a pet 1B according to still another embodiment as viewed from the skin surface side Z1. The absorbent article for a pet 1B illustrated in FIG. 8 is different from the absorbent article for a pet 1 illustrated in FIG. 1 in that the body portion 2 includes a plurality of inner elastic members 63B instead of the plurality of inner elastic members 63. In the following description, differences from the absorbent article for a pet 1 will be mainly described, and redundant description will be omitted.

The body portion 2 of the absorbent article for a pet 1B includes the plurality of inner elastic members 63B expandable in the longitudinal direction Y. The plurality of inner elastic members 63B are provided in the second portion 2B of the body portion 2. More specifically, the plurality of inner elastic members 63B are provided at the second end portion 8. Accordingly, a center P5 of the inner elastic member 63B in the longitudinal direction Y is disposed on the second side edge 6 side with respect to the center line P4 of the absorber 30 in the longitudinal direction Y.

The first portion 2A of the body portion 2 includes a non-expandable region R3 not including the inner elastic member 63B, and the second portion 2B of the body portion 2 includes an expandable region R4 including the inner elastic member 63B. In the embodiment illustrated in FIG. 8, the first end portion 7 includes the non-expandable region R3, and the second end portion 8 includes the expandable region R4. Accordingly, a contraction rate of the second portion 2B is higher than a contraction rate of the first portion 2A. That is, a contraction rate of the second end portion 8 is higher than a contraction rate of the first end portion 7. Note that, a part of the plurality of inner elastic members 63B may extend from the second side edge 6 to the middle of the first portion 2A, and only a part of the first portion 2A may constitute the non-expandable region R3.

In the absorbent article for a pet 1B, the engagement portion 70 is provided on the outer surface of the back surface sheet 20. The engagement portion 70 can be directly engaged with the front surface sheet 15 from the skin surface side Z1. Note that, in a case where the target portion is provided on the front surface sheet 15, the engagement portion 70 may be engageable with the front surface sheet 15 via the target portion. In the absorbent article for a pet 1B, the engagement portion 70 is engaged with the front surface of the front surface sheet 15.

The absorbent article for a pet 1B having the above configuration can be worn on the pet as follows. First, the user presses the first end portion 7 of the absorbent article for a pet 1B against the back of the pet, and presses the vicinity of the first end portion 7 with one hand. Next, the user holds the second end portion 8 of the absorbent article for a pet 1B with the other hand, and winds the absorbent article for a pet 1B so as to cover the belly of the pet. Next, the user pulls up the second end portion 8 such that the absorbent article for a pet 1B comes into close contact with the body of the pet, and then engages the engagement portion 70 with the front surface of the front surface sheet 15 at the first end portion 7.

At this time, since the contraction rate of the second portion 2B is higher than the contraction rate of the first portion 2A, the first portion 2A can be brought into contact with the body of the pet to easily align the absorbent article for a pet 1B. In addition, since the second portion 2B contracts and the absorbent article for a pet 1B comes into close contact with the body of the pet, the fitting of the absorbent article for a pet 1B is improved.

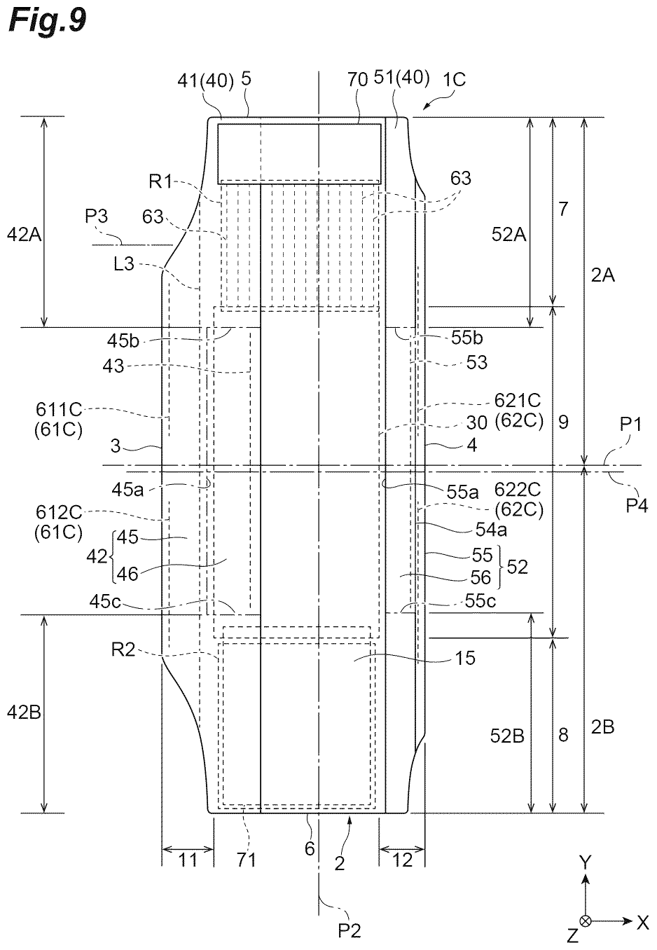

Next, an absorbent article for a pet according to still another embodiment will be described. FIG. 9 is a plan view of an absorbent article for a pet 1C according to still another embodiment as viewed from the skin surface side Z1. The absorbent article for a pet 1C illustrated in FIG. 9 is different from the absorbent article for a pet 1 illustrated in FIG. 1 in that the body portion 2 includes a pair of outer elastic members 61C and 62C instead of the pair of outer elastic members 61 and 62.

As illustrated in FIG. 9, the outer elastic members 61C and 62C are provided outside the pair of first rising lines 45a and fourth rising lines 55a in the lateral direction X. The outer elastic member 61C extends along the front edge 3, and the outer elastic member 62C extends along the rear edge 4. Each of the outer elastic members 61C and 62C is discontinuously formed in the longitudinal direction Y. More specifically, the outer elastic member 61C includes a first portion 611C and a second portion 612C apart from each other in the longitudinal direction Y. The first portion 611C is disposed on one side in the longitudinal direction Y with respect to the center line P4 of the absorber 30, and the second portion 612C is disposed on the other side in the longitudinal direction Y with respect to the center line P4 of the absorber 30. A non-expandable region in which the outer elastic member 61C is not disposed is formed between the first portion 611C and the second portion 612C. The non-expandable region is formed so as to straddle the center line P1 in the longitudinal direction Y.

In addition, the outer elastic member 62C includes a first portion 621C and a second portion 622C apart from each other in the longitudinal direction Y. The first portion 621C is disposed on one side in the longitudinal direction Y with respect to the center line P4 of the absorber 30, and the second portion 622C is disposed on the other side in the longitudinal direction Y with respect to the center line P4 of the absorber 30. A non-expandable region in which the outer elastic member 61C is not disposed is formed between the first portion 621C and the second portion 622C. The non-expandable region is formed so as to straddle the center line P1 in the longitudinal direction Y.

Depending on the type of pet, there may be less hairs around the stomach. In such a case, when the outer elastic member 61C presses the stomach of the pet, the pet may feel pain. In contrast, since the non-expandable region in which the outer elastic member 61C is not disposed is formed between the first portion 611C and the second portion 612C of the outer elastic member 61C, it is possible to prevent the pet's stomach from being pressed by the outer elastic member 61C.

In addition, when the outer elastic member 62C presses the genital organ of the pet, the genital organ may rub and blacken, or the pet may feel pain. In contrast, the non-expandable region in which the outer elastic member 62C is not disposed is formed between the first portion 621C and the second portion 622C of the outer elastic member 62C, and thus, it is possible to prevent the genital organ of the pet from being pressed by the outer elastic member 62C.

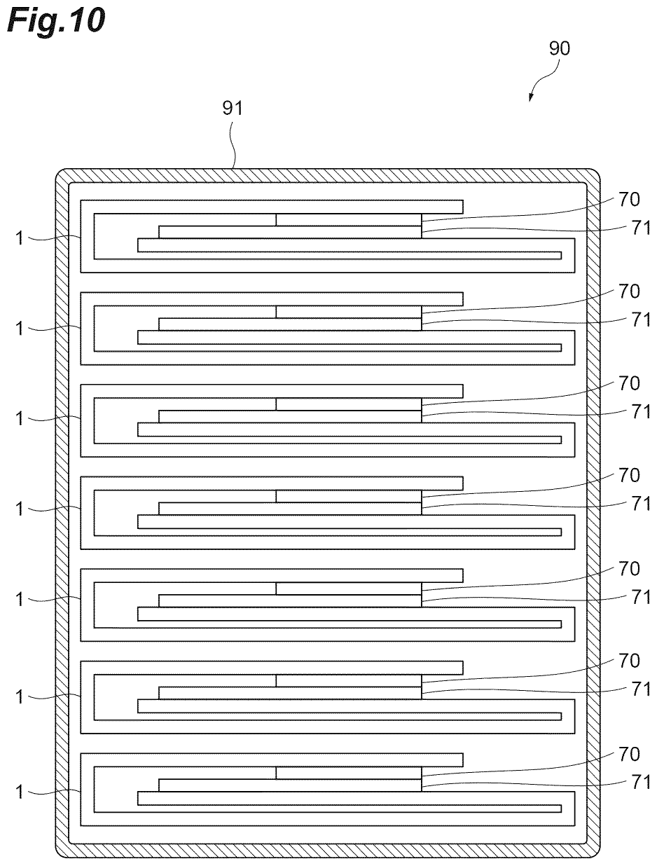

Next, a package 90 for accommodating a plurality of absorbent articles for a pet 1 will be described. FIG. 10 is a sectional view illustrating the package 90 according to one embodiment. The package 90 includes a packaging sheet 91 for packaging the plurality of absorbent articles for a pet 1. In FIG. 10, the absorbent article for a pet 1 is packaged in the packaging sheet 91 in a state where the body portion 2 is folded in three in the longitudinal direction Y. Note that, the absorbent article for a pet 1 may be accommodated in the packaging sheet 91 in a state of being folded in four in the longitudinal direction Y. The packaging sheet 91 is made of, for example, a synthetic resin such as polyethylene, polypropylene, or polyethylene terephthalate.

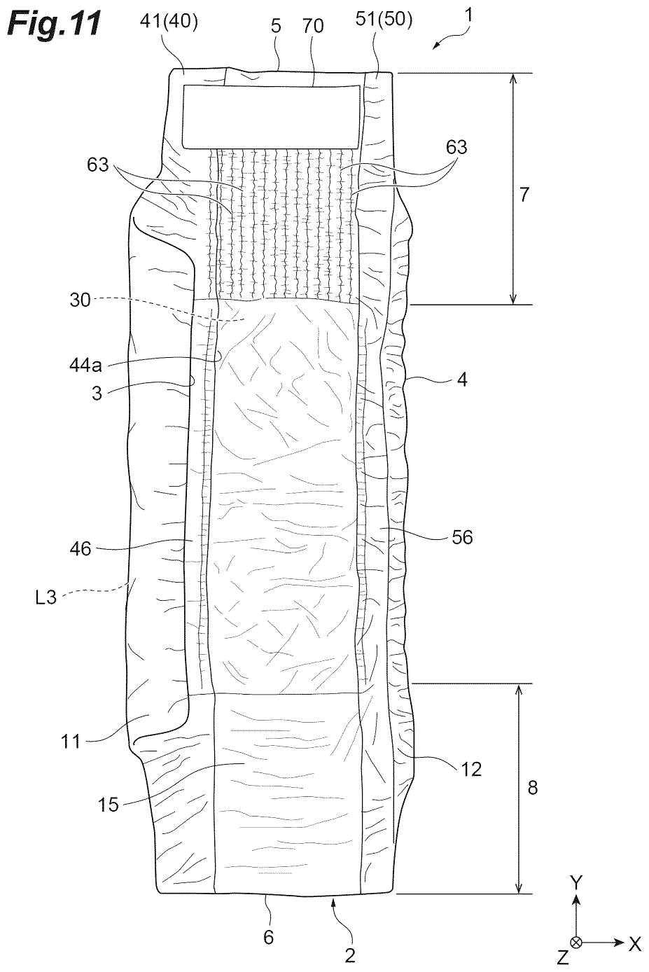

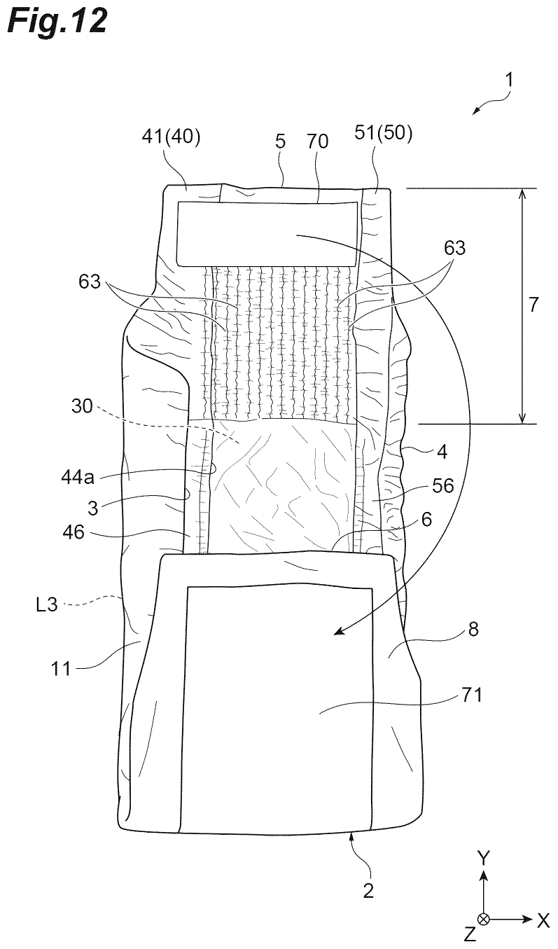

Next, a procedure for folding the absorbent article for a pet 1 will be described with reference to FIGS. 11 and 12. First, as illustrated in FIG. 11, the front flap portion 11 is folded inward along a folding line L3 extending in the longitudinal direction Y such that the inner edge 44a of the front leakage-preventing sheet 41 in the lateral direction X is exposed. As illustrated in FIG. 2, the folding line L3 is positioned closer to the front edge 3 than an intermediate line between the front edge 3 and the inner edge 44a in the lateral direction X. That is, a distance between the front edge 3 and the folding line L3 in the lateral direction X is shorter than a distance between the inner edge 44a and the folding line L3 in the lateral direction X. The front flap portion 11 is folded along the folding line L3, and thus, the inner edge 44a of the side sheet 42 is exposed. On the other hand, the rear flap portion 12 is not folded inward in the lateral direction X.

Next, as illustrated in FIG. 12, the body portion 2 is folded in three in the longitudinal direction Y. More specifically, after the second end portion 8 is folded inward in the longitudinal direction Y, the first end portion 7 is folded inward in the longitudinal direction Y so as to overlap the second end portion 8. At this time, the engagement portion 70 is engaged with the target portion 71. The absorbent article for a pet 1 folded as described above is accommodated in the package 90.

As described above, in the package 90, the inner edge 44a of the front leakage-preventing sheet 41 in the lateral direction X is exposed when the folded absorbent article for a pet 1 is unfolded in the longitudinal direction Y. As a result, even though the absorbent article for a pet 1 is worn after the body portion folded in three is opened, the front leakage-preventing sheet 41 reliably comes into contact with the body of the pet, and as a result, urine leakage can be effectively suppressed by the front leakage-preventing sheet 41. Accordingly, even in a case where the absorbent article for a pet 1 is worn without spreading the front flap portion 11, since the front leakage-preventing sheet 41 comes into contact with the body of the pet, urine leakage can be suppressed by the front leakage-preventing sheet 41.

In addition, in the package 90, since the rear flap portion 12 is not folded inward in the lateral direction X, when the absorbent article for a pet 1 is taken out from the package 90, the user can easily recognize a front-back orientation of the absorbent article for a pet 1. For example, since it is possible to easily recognize where the front leakage-preventing sheet 41 is positioned in the absorbent article for a pet 1, it is possible to easily put the absorbent article for a pet 1 such that the front leakage-preventing sheet 41 is disposed on the head side of the pet.

Although the absorbent articles for a pet according to various embodiments have been described above, the present invention is not limited to the above-described embodiments, and various modifications can be made without changing the gist of the invention. That is, it should be noted that the above-described embodiments are for the purpose of illustration and are not intended to limit the scope of the present invention.

For example, in each of the absorbent articles for a pet 1, 1A, 1B, and 1C described above, the front leakage-preventing sheet 41 may not include the first elastic member 43, and the rear leakage-preventing sheet 51 may not include the first elastic member 53. In addition, each of the absorbent articles for a pet 1, 1A, 1B, and 1C may not include the pair of leakage-preventing sheets 40.

In each of the absorbent articles for a pet 1, 1A, 1B, and 1C described above, the front surface sheet 15 in the first portion 2A and the front surface sheet 15 in the second portion 2B may be engaged with each other. In addition, in each of the absorbent articles for a pet 1, 1A, 1B, and 1C, the back surface sheet 20 in the first portion 2A and the back surface sheet 20 in the second portion 2B may be engaged with each other. The various embodiments described above can be combined within a consistent range.

### REFERENCE SIGNS LIST

1, 1A, 1B, 1C absorbent article for pet
2 body portion
2A first portion
2B second portion
11 front flap portion
12 rear flap portion
15 front surface sheet
20 back surface sheet
30 absorber
40 leakage-preventing sheet
41 front leakage-preventing sheet
44a inner edge
45a first rising line
55a fourth rising line (second rising line)
51 rear leakage-preventing sheet
61, 61C, 62, 62C outer elastic member
63, 63A, 63B inner elastic member
70 engagement portion
70a inner region
70b central region
70c inner region
90 package
L3 folding line
P1, P2, P4 center line
P3, P5 center
R1, R4 expandable region
R2, R3 non-expandable region
X lateral direction
Y longitudinal direction
Z thickness direction
Z1 skin surface side
Z2 non-skin surface side

1. An absorbent article for a pet worn by being wound around a body of the pet, the absorbent article comprising:
a body portion having a horizontally long shape having a longitudinal direction and a lateral direction, the body portion including a front surface sheet disposed on a skin surface side, a back surface sheet disposed on a non-skin surface side, and an absorber disposed between the front surface sheet and the back surface sheet, and the body portion including a first portion disposed on one side in the longitudinal direction with respect to a center line of the body portion in the longitudinal direction, and a second portion disposed on the other side in the longitudinal direction with respect to the center line of the body portion in the longitudinal direction;
an engagement portion that is provided in the first portion of the body portion and engages the first portion and the second portion;
a pair of leakage-preventing sheets capable of rising with respect to the front surface sheet along a pair of rising lines extending in the longitudinal direction at positions apart from each other in the lateral direction; and
a pair of outer elastic members provided outside the pair of rising lines in the lateral direction and expandable in the longitudinal direction,
wherein the body portion further includes one or more inner elastic members provided inside the pair of rising lines in the lateral direction and imparting expandability to the body portion.

2. The absorbent article for a pet according to claim 1, wherein the one or more inner elastic members expand and contract in the longitudinal direction.

3. The absorbent article for a pet according to claim 2, wherein the one or more inner elastic members extend over an entire region of the body portion in the longitudinal direction.

4. The absorbent article for a pet according to claim 2, wherein the engagement portion is provided on a front surface of the front surface sheet and is engageable with the back surface sheet.

5. The absorbent article for a pet according to claim 4,
wherein the first portion includes an expandable region including the one or more inner elastic members,
the second portion includes a non-expandable region not including the one or more inner elastic members, and
a contraction rate of the first portion is higher than a contraction rate of the second portion.

6. The absorbent article for a pet according to claim 4, wherein a center of the one or more inner elastic members in the longitudinal direction is disposed on the one side in the longitudinal direction with respect to a center line of the absorber in the longitudinal direction.

7. The absorbent article for a pet according to claim 2, wherein the engagement portion is provided on an outer surface of the back surface sheet and is engageable with the front surface sheet.

8. The absorbent article for a pet according to claim 7,
wherein the first portion includes a non-expandable region not including the one or more inner elastic members,
the second portion includes an expandable region including the one or more inner elastic members, and
a contraction rate of the second portion is higher than a contraction rate of the first portion.

9. The absorbent article for a pet according to claim 7, wherein a center of the one or more inner elastic members in the longitudinal direction is disposed on the other side in the longitudinal direction with respect to a center line of the absorber in the longitudinal direction.

10. The absorbent article for a pet according to claim 2, wherein the one or more inner elastic members overlap the engagement portion as viewed from a thickness direction of the body portion.

11. The absorbent article for a pet according to claim 1, wherein the one or more inner elastic members do not overlap the engagement portion

12. The absorbent article for a pet according to claim 1, wherein the one or more inner elastic members do not overlap the absorber as viewed from a thickness direction of the body portion.

13. The absorbent article for a pet according to claim 1, wherein the one or more inner elastic members overlap the absorber as viewed from a thickness direction of the body portion.

14. The absorbent article for a pet according to claim 1, wherein each of the pair of outer elastic members continuously extends in the longitudinal direction.

15. The absorbent article for a pet according to claim 1, wherein each of the pair of outer elastic members is discontinuously formed in the longitudinal direction.

16. The absorbent article for a pet according to claim 1,
wherein the pair of leakage-preventing sheets includes a front leakage-preventing sheet capable of rising along a first rising line of the pair of rising lines and a rear leakage-preventing sheet capable of rising along a second rising line of the pair of rising lines, and
a maximum rising height of the front leakage-preventing sheet with the body portion as a reference is higher than a maximum rising height of the rear leakage-preventing sheet with the body portion as the reference.

17. The absorbent article for a pet according to claim 1,
wherein the body portion includes the plurality of inner elastic members, and
the plurality of inner elastic members are arrayed along the lateral direction.

18. An absorbent article for a pet worn by being wound around a body of the pet, the absorbent article comprising:
a body portion having a horizontally long shape having a longitudinal direction and a lateral direction, the body portion including a front surface sheet disposed on a skin surface side, a back surface sheet disposed on a non-skin surface side, and an absorber disposed between the front surface sheet and the back surface sheet, and the body portion including a first portion disposed on one side in the longitudinal direction with respect to a center line of the body portion in the longitudinal direction, and a second portion disposed on the other side in the longitudinal direction with respect to the center line of the body portion in the longitudinal direction;
an engagement portion that is provided in the first portion of the body portion and engages the first portion and the second portion; and
a pair of outer elastic members provided outside the absorber in the lateral direction and expandable in the longitudinal direction,
wherein the body portion further includes one or more inner elastic members disposed on the non-skin surface side with respect to the front surface sheet and imparting expandability to the body portion, and
the one or more inner elastic members are provided inside the pair of outer elastic members in the lateral direction, and overlap the engagement portion as viewed from a thickness direction of the body portion.

19. The absorbent article for a pet according to claim 18, wherein, when regions obtained by dividing the engagement portion into three equal regions in the lateral direction are defined as a front region, a central region, and a rear region in order from one side in the lateral direction, the one or more inner elastic members overlap at least the central region as viewed from the thickness direction of the body portion.

20. A package that accommodates the absorbent article for a pet according to claim 1,
wherein the body portion includes a front flap portion and a rear flap portion disposed outside the absorber in the lateral direction,
the pair of leakage-preventing sheets includes a front leakage-preventing sheet capable of rising along a first rising line of the pair of rising lines and a rear leakage-preventing sheet capable of rising along a second rising line of the pair of rising lines, and
the absorbent article for a pet is accommodated in the package in a state where the body portion is folded in three or folded in four in the longitudinal direction after the front flap portion is folded inward along a folding line extending in the longitudinal direction so as to expose an inner edge of the front leakage-preventing sheet in the lateral direction.

21. (canceled)
